(19) United States
(12) Patent Application Publication
(10) Pub. No.: US 2011/0063288 A1
(43) Pub. Date: Mar. 17, 2011

(54) Transfer function for volume rendering

(75) Inventor: Gerardo Hermosillo Valadez, West Chester, PA (US)

(73) Assignee: Siemens Medical Solutions USA, Inc., Malvern, PA (US)

(21) Appl. No.: 12/807,681

(22) Filed: Sep. 10, 2010

Related U.S. Application Data
(60) Provisional application No. 61/241,699, filed on Sep. 11, 2009.

(51) Int. Cl. G06T 15/00; G06K 9/00

(52) U.S. Cl. 345/419; 382/131

(57) ABSTRACT

Described herein is a technology for facilitating visualization of image data. In one implementation, rendering is performed by a computer system to generate a three-dimensional representation of a region of interest from the image data based on a transfer function. In one implementation, the transfer function causes the computer system to render voxels representing a material that is likely to occlude the region of interest from a desired viewpoint as at least partially transparent. In addition, one or more features within the region of interest may be visually distinguished according to a color scheme.

### CROSS-REFERENCE TO RELATED APPLICATION

The present application claims the benefit of U.S. provisional application No. 61/241,699 filed Sep. 11, 2009, the entire contents of which are herein incorporated by reference.

### TECHNICAL FIELD

The present disclosure relates generally to automated or partially-automated rendering of image data, and more particularly to volume rendering of image data with a transfer function.

### BACKGROUND

The field of medical imaging has seen significant advances since the time x-rays were first used to determine anatomical abnormalities. Medical imaging hardware has progressed in the form of newer machines such as Medical Resonance Imaging (MRI) scanners, Computed Axial Tomography (CAT) scanners, etc. Because of the large amount of image data generated by such modern medical scanners, there has been and remains a need for developing image processing techniques that can automate some or all of the processes to determine the presence of anatomical structures and abnormalities in scanned medical images.

Recognizing anatomical structures within digitized medical images presents multiple challenges. For example, a first concern relates to the accuracy of recognition of anatomical structures within an image. A second area of concern is the speed of recognition. Because medical images are an aid for a doctor to diagnose a disease or medical condition, the speed with which an image can be processed and structures within that image recognized can be of the utmost importance to the doctor reaching an early diagnosis. Hence, there is a need for improving recognition techniques that provide accurate and fast recognition of anatomical structures and possible abnormalities in medical images.

Digital medical images are constructed using raw image data obtained from a scanner, for example, a CAT scanner, MRI, etc. Digital medical images are typically either a two-dimensional (“2-D”) image made of pixel elements or a three-dimensional (“3-D”) image made of volume elements (“voxels”). Such 2-D or 3-D images are processed using medical image recognition techniques to determine the presence of anatomical structures such as cysts, tumors, polyps, etc. Given the amount of image data generated by any given image scan, it is preferable that an automatic technique should point out anatomical features in the selected regions of an image to a doctor for further diagnosis of any disease or medical condition.

One general method of automatic image processing employs feature based recognition techniques to determine the presence of anatomical structures in medical images. However, feature based recognition techniques can suffer from accuracy problems.

Automatic image processing and recognition of structures within a medical image is generally referred to as Computer-Aided Detection (CAD). A CAD system can process medical images and identify anatomical structures including possible abnormalities for further review. Such possible abnormalities are often called candidates and are considered to be generated by the CAD system based upon the medical images.

With the advent of sophisticated medical imaging modalities, such as Computed Tomography (CT), three-dimensional (3D) volumetric data sets can be reconstructed from a series of two-dimensional (2D) X-ray slices of an anatomical structure taken around an axis of rotation. Such 3D volumetric data may be displayed using volume rendering techniques so as to allow a physician to view any point inside the anatomical structure, without the need to insert an instrument inside the patient's body.

One exemplary use of CT is in the area of preventive medicine. For example, CT colonography (also known as virtual colonoscopy) is a valuable tool for early detection of colonic polyps that may later develop into colon cancer (or colorectal cancer). Studies have shown that early detection and removal of precursor polyps effectively prevents colon cancer. CT colonography uses CT scanning to obtain volume data that represents the interior view of the colon (or large intestine). It is minimally invasive and more comfortable for patients than traditional optical colonoscopy. From CT image acquisitions of the patient's abdomen, the radiologist may inspect suspicious polyps attached to the colon wall by examining 2D reconstructions of individual planes of the image data or performing a virtual fly-through of the interior of the colon from the rectum to the cecum, thereby simulating a manual optical colonoscopy.

FIG. 1 shows a 3D virtual endoscopic view 100 of a colon wall 102 reconstructed from CT images by computer-aided diagnosis (CAD) software. By using a 3D reading mode of the CAD software, radiologists may look at a 3D surface rendering of the colon wall 102 and more carefully evaluate any suspicious polypoid structure 104 on it. One disadvantage of the 3D reading mode, however, is that it only provides geometric information (e.g., width, depth, height) about the imaged structure, but not intensity values (or brightness levels) generated as a result of different physical properties (e.g., density) of the structure. In order to perform a full assessment of any potential lesion, the radiologist often has to return to the 2D reading mode provided by the CAD software. Many false-positives or benign structures can only be dismissed after switching to the 2D reading mode for evaluation. Such evaluation process is very time-consuming and error-prone.

FIG. 2 shows an image 200 generated by the CAD software in the 2D reading mode. In most cases, the evaluation in 2D reading mode is triggered by the appearance of suspicious-looking structures in the 3D reading mode. Upon assessing the image intensity values in 2D mode, the radiologist may determine lesion 202 to be a benign lipoma and dismiss it as a false-positive. Similarly, other types of polypoid-shaped structures (e.g., fecal material or stool) that initially appear to be suspicious in the 3D reading mode can later be dismissed after inspecting the intensity properties of the 2D reconstructed image.

To further facilitate diagnosis, shading, colors, or pseudo colors may be overlaid on the 3D surface rendering to differentiate between different tissue types, such as lipoma and adenoma, polyps and tagged stool. For example, FIG. 3a shows an image 300 with a 3D surface rendering of tagged stool 302. FIG. 3b illustrates a 2D “polyp lens” 304 overlaid on the 3D image 300. The “polyp lens” 304 provides a local shading coded 2D reconstruction of the image data on top of the 3D surface rendering of the tagged stool 302.

The problem with such visualization techniques, however, is the inefficiency in having to switch between 2D and 3D reading modes. Reviewing images in such environment can be time-consuming and counter-intuitive. Lesions may be missed as a result of such evaluation. Therefore, there is a need for providing a more enhanced visualization technology that readily prevents such errors.

### SUMMARY

According to one aspect of the present disclosure, a method of visualization is described, comprising receiving digitized image data, including image data of a region of interest, and rendering a three-dimensional representation of the region of interest based on a transfer function, wherein the transfer function causes a computer system to render voxels representing a material that is likely to occlude the region of interest from a desired viewpoint as at least partially transparent and to render voxels representing one or more features within the region of interest in accordance with a color scheme. The method can include acquiring, by an imaging device, the image data by computed tomography (CT). The method can include pre-processing the image data by segmenting the one or more features in the region of interest. The image data can be image data of a tube-like structure, including for example, a colon. The desired viewpoint can be outside of a tube-like structure and the region of interest can be within an interior portion of the tube-like structure. The material can be material of a wall section of a tube-like structure, wherein the wall section is positioned between the region of interest and the desired viewpoint. The one or more features in the region of interest can be muscle tissue. The method can include receiving, via a user interface, a user selection of the region of interest. The rendering can include volume ray casting, splatting, shear warping, texture mapping, hardware-accelerated volume rendering or a combination thereof. The color scheme can map intensity ranges to color values, wherein at least one of the intensity ranges is associated with a type of material. The color scheme can be perceptually distinctive colors. The color scheme can include additive primary colors.

According to another aspect of the present disclosure a method of generating a virtual view of a colon for use in virtual colonoscopy is presented, the method including receiving digitized image data of a portion of a colon including a region of interest within an interior portion of the colon, and rendering, by the computer system, a three-dimensional representation of the portion of the colon based on a transfer function, wherein the transfer function causes a computer system to render voxels representing any wall portion of the colon as at least partially transparent and to render voxels representing one or more features in the region of interest in accordance with a color scheme. The method can include acquiring, by an imaging device, the image data by computed tomography (CT). The transfer function further can cause the computer system to render voxels representing fatty tissue as transparent. The one or more features in the region of interest can include detected false positives. The one or more features in the region of interest can include detected true positives.

According to yet another aspect of the present disclosure, a computer readable medium embodying a program of instructions executable by machine to perform steps for visualization is presented. The steps including receiving digitized image data, including image data of a region of interest, and rendering a three-dimensional representation of the region of interest based on a transfer function, wherein the transfer function causes the machine to render voxels representing a material that is likely to occlude the region of interest from a desired viewpoint as at least partially transparent and to render voxels representing one or more features within the region of interest in accordance with a color scheme.

According to another aspect of the present disclosure, a visualization system is presented including a memory device for storing computer readable program code, and a processor in communication with the memory device, the processor being operative with the computer readable program code to receive digitized image data, including image data of a region of interest, and render a three-dimensional representation of the region of interest based on a transfer function, wherein the transfer function causes the processor to render voxels representing a material that is likely to occlude the region of interest from a desired viewpoint as at least partially transparent and to render voxels representing one or more features within the region of interest in accordance with a color scheme.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

The patent or application file contains at least one drawing executed in color. Copies of this patent or patent application publication with color drawing(s) will be provided by the Office upon request and payment of the necessary fee. Furthermore, it should be noted that the same numbers are used throughout the drawings to reference like elements and features.

FIG. 1 shows a 3D virtual endoscopic view of a colon wall;

FIG. 2 shows an image generated by a CAD software in a 2D reading mode;

FIG. 3a shows an image with a 3D surface rendering of tagged stool;

FIG. 3b illustrates a 2D “polyp lens” overlaid on a 3D image;

FIG. 4 shows a block diagram illustrating an exemplary system;

FIG. 5 shows an exemplary method;

FIG. 6 shows an image that illustrates an exemplary transfer function;

FIG. 7a shows an image generated by volume rendering without applying the present transfer function;

FIG. 7b shows an image generated by volume rendering based on an exemplary transfer function;

FIG. 8a shows an image generated by standard volume rendering;

FIG. 8b shows an image generated by volume rendering based on an exemplary transfer function;

FIG. 9a shows an image generated by a standard volume rendering;

FIG. 9b shows an image generated by volume rendering based on an exemplary transfer function;

FIG. 10a shows images generated by standard volume rendering; and

FIG. 10b shows images generated by volume rendering based on an exemplary transfer function.

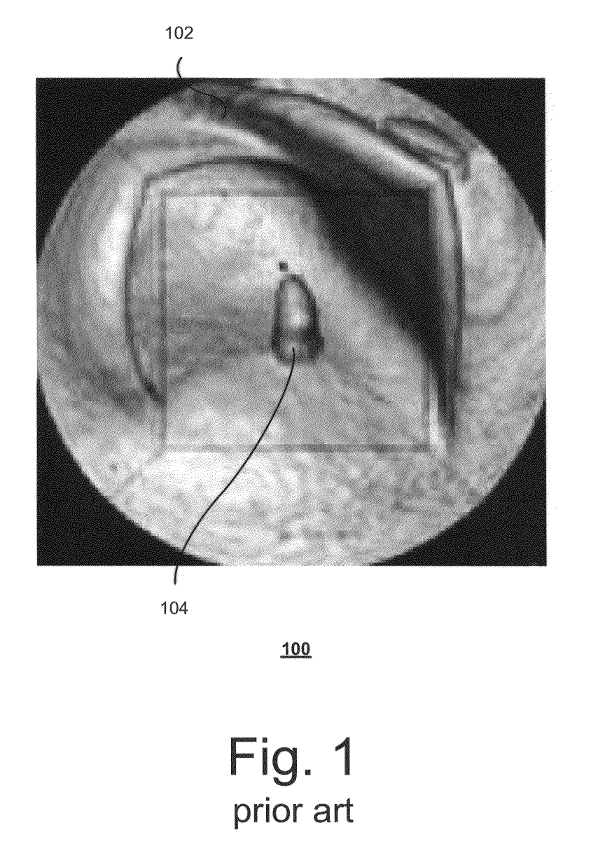

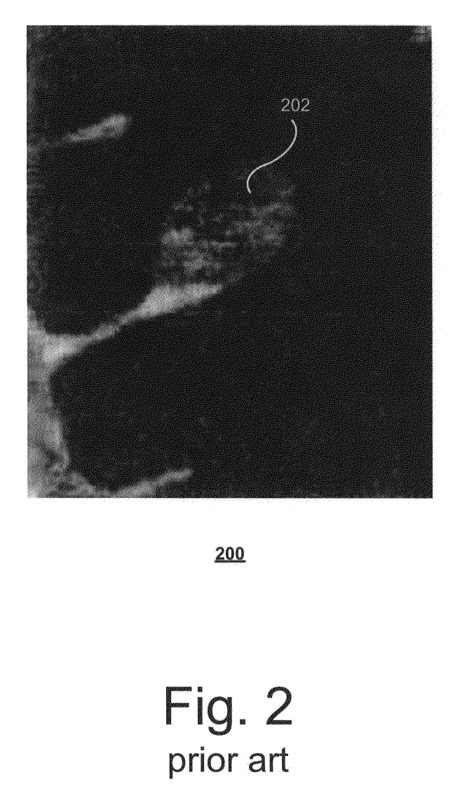

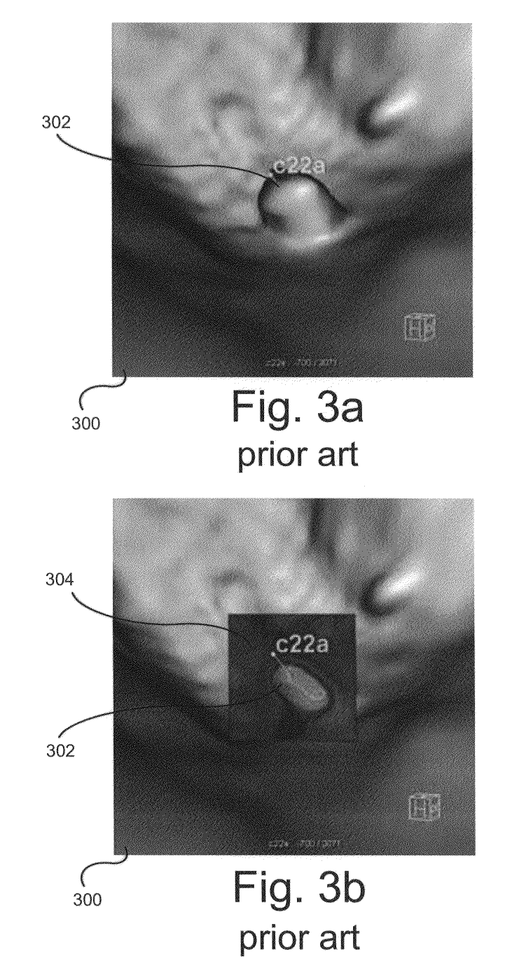

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The term “x-ray image” as used herein may mean a visible x-ray image (e.g., displayed on a video screen) or a digital representation of an x-ray image (e.g., a file corresponding to the pixel output of an x-ray detector). The term “in-treatment x-ray image” as used herein may refer to images captured at any point in time during a treatment delivery phase of a radiosurgery or radiotherapy procedure, which may include times when the radiation source is either on or off. From time to time, for convenience of description, CT imaging data may be used herein as an exemplary imaging modality. It will be appreciated, however, that data from any type of imaging modality including but not limited to X-Ray radiographs, MRI, CT, PET (positron emission tomography), PET-CT, SPECT, SPECT-CT, MR-PET, 3D ultrasound images or the like may also be used in various embodiments of the invention.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulate and transform data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

As used herein, the term “image” refers to multi-dimensional data composed of discrete image elements (e.g., pixels for 2D images and voxels for 3D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2D picture or a 3D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The following description sets forth one or more implementations of systems and methods that facilitate visualization of image data. One implementation of the present framework uses a volume rendering technique based on a transfer function to display a three-dimensional (3D) representation of the image data set. In one implementation, the transfer function causes the computer system to render any voxels likely to occlude a region of interest from a desired viewpoint as at least partially transparent. In addition, features in the region of interest may be distinguished with different shading or color values. For example, in the context of virtual colonoscopy, the colon wall may be made semi-transparent, while the underlying tissue and tagged fecal material may be color-coded or shading-coded in accordance with a color or shading scheme, respectively, for direct differentiation. This advantageously allows the user to view features behind the colon wall in a 3D reading mode during a fly-through inspection, without having to switch to a 2D reading mode.

It is understood that while a particular application directed to virtual colonoscopy is shown, the technology is not limited to the specific embodiment illustrated. The present technology has application to, for example, visualizing features in other types of luminal, hollow or tube-like anatomical structures (e.g., airways, urinary tract, blood vessels, bronchia, gall bladder, arteries, etc.). In addition, the present technology has application to both medical application (e.g., disease diagnosis) and non-medical applications (e.g., engineering applications).

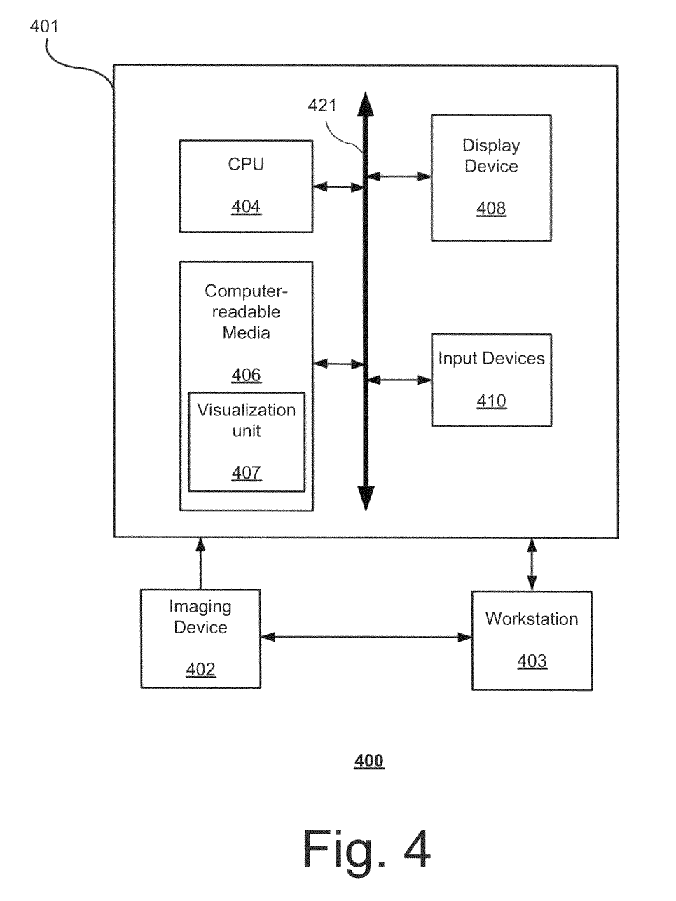

FIG. 4 shows a block diagram illustrating an exemplary system 400. The system 400 includes a computer system 401 for implementing the framework as described herein. The computer system 401 may be further connected to an imaging device 402 and a workstation 403, over a wired or wireless network. The imaging device 402 may be a radiology scanner such as a magnetic resonance (MR) scanner or a CT scanner.

Computer system 401 may be a desktop personal computer, a portable laptop computer, another portable device, a mini-computer, a mainframe computer, a server, a storage system, a dedicated digital appliance, or another device having a storage sub-system configured to store a collection of digital data items. In one implementation, computer system 401 comprises a processor or central processing unit (CPU) 404 coupled to one or more computer-readable media 406 (e.g., computer storage or memory), display device 408 (e.g., monitor) and various input devices 410 (e.g., mouse or keyboard) via an input-output interface 421. Computer system 401 may further include support circuits such as a cache, power supply, clock circuits and a communications bus.

It is to be understood that the present technology may be implemented in various forms of hardware, software, firmware, special purpose processors, or a combination thereof. In one implementation, the techniques described herein may be implemented as computer-readable program code tangibly embodied in computer-readable media 406. In particular, the techniques described herein may be implemented by visualization unit 407. Computer-readable media 406 may include random access memory (RAM), read only memory (ROM), magnetic floppy disk, flash memory, and other types of memories, or a combination thereof. The computer-readable program code is executed by CPU 404 to process images (e.g., MR or CT images) from imaging device 402 (e.g., MR or CT scanner). As such, the computer system 401 is a general-purpose computer system that becomes a specific purpose computer system when executing the computer readable program code. The computer-readable program code is not intended to be limited to any particular programming language and implementation thereof. It will be appreciated that a variety of programming languages and coding thereof may be used to implement the teachings of the disclosure contained herein.

In one implementation, computer system 401 also includes an operating system and microinstruction code. The various techniques described herein may be implemented either as part of the microinstruction code or as part of an application program or software product, or a combination thereof, which is executed via the operating system. Various other peripheral devices, such as additional data storage devices and printing devices, may be connected to the computer system 401.

The workstation 403 may include a computer and appropriate peripherals, such as a keyboard and display, and can be operated in conjunction with the entire CAD system 400. For example, the workstation 403 may communicate with the imaging device 402 so that the image data collected by the imaging device 402 can be rendered at the workstation 403 and viewed on the display. The workstation 403 may include a user interface that allows the radiologist or any other skilled user (e.g., physician, technician, operator, scientist, etc.), to manipulate the image data. For example, the user may identify regions of interest in the image data, or annotate the regions of interest using pre-defined descriptors via the user-interface. Further, the workstation 403 may communicate directly with computer system 401 to display processed image data. For example, a radiologist can interactively manipulate the displayed representation of the processed image data and view it from various viewpoints and in various reading modes.

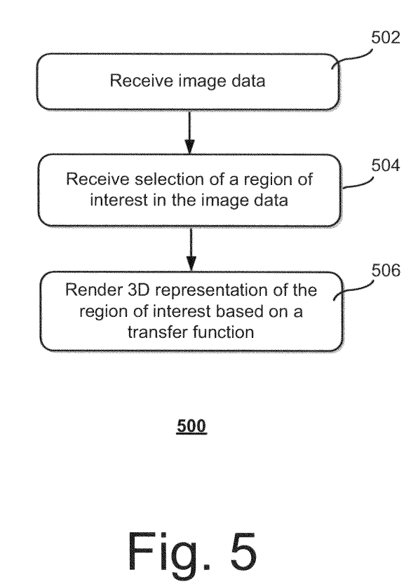

FIG. 5 shows an exemplary method 500. In one implementation, the exemplary method 500 is implemented by the visualization unit 407 in computer system 401, previously described with reference to FIG. 4. It should be noted that in the discussion of FIG. 5 and subsequent figures, continuing reference may be made to elements and reference numerals shown in FIG. 4.

At step 502, the computer system 401 receives image data. The image data includes one or more digitized images acquired by, for example, imaging device 402. The imaging device 402 may acquire the images by techniques that include, but are not limited to, magnetic resonance (MR) imaging, computed tomography (CT), helical CT, x-ray, positron emission tomography, fluoroscopic, ultrasound or single photon emission computed tomography (SPECT). The images may include one or more intensity values that indicate certain material properties. For example, CT images include intensity values indicating radiodensity measured in Hounsfield Units (HU). Other types of material properties may also be associated with the intensity values. The images may be binary (e.g., black and white), color, or grayscale. In addition, the images may comprise two dimensions, three dimensions, four dimensions or any other number of dimensions. Further, the images may comprise medical images of an anatomical feature, such as a tube-like or luminal anatomical structure (e.g., colon), or a non-anatomical feature.

The image data may be pre-processed, either automatically by the computer system 401, manually by a skilled user (e.g., radiologist), or a combination thereof. Various types of pre-processing may be performed. For example, the images may be pre-filtered to remove noise artifacts or to enhance the quality of the images for ease of evaluation.

In one implementation, pre-processing includes segmenting features in the images. Such features may include detected false-positives, such as polypoid-shaped fecal residue, haustral folds, extra-colonic candidates, ileocecal valve or cleansing artifacts. Such features may also include detected true-positives such as polyps or potentially malignant lesions, tumors or masses in the patient's body. In one implementation, the features are automatically detected by the computer system 401 using a CAD technique, such as one that detects points where the change in intensity exceeds a certain threshold. Alternatively, features may be identified by a skilled user via, for example, a user-interface at the workstation 403. The features may also be tagged, annotated or marked for emphasis or to provide additional textual information so as to facilitate interpretation.

At 504, the visualization unit 407 receives a selection of a region of interest (ROI). An ROI generally refers to an area or volume of data identified from the image data for further study or investigation. In particular, an ROI may represent an abnormal medical condition or suspicious-looking feature. In one implementation, a graphical user interface is provided for a user to select a region of interest for viewing. For example, the user may select a section of a colon belonging to a certain patient to view. A virtual fly-through (or video tour) may be provided so as to allow the user to obtain views that are similar to a clinical inspection (e.g., colonoscopy). The user can interactively position the virtual camera (or viewpoint) outside the colon to inspect the region of interest inside the colon. In such case, the colon wall is positioned between the region of interest and the desired viewpoint, and may potentially occlude the view of the region of interest. One aspect of the present framework advantageously renders the colon wall as at least semi-transparent to facilitate closer inspection of the region of interest without having to switch to a 2D reading mode, as will be described in more detail later.

At 506, a three-dimensional (3D) representation of the region of interest is rendered based on a transfer function. The image is rendered for display on, for example, output display device 408. In addition, the rendered image may be stored in a raw binary format, such as the Digital Imaging and Communications in Medicine (DICOM) or any other file format suitable for reading and rendering image data for display and visualization purposes.

The image may be generated by performing one or more volume rendering techniques, volume ray casting, ray tracing, splatting, shear warping, texture mapping, or a combination thereof. For example, a ray may be projected from a viewpoint for each pixel in the frame buffer into a volume reconstructed from the image data. As the ray is cast, it traverses through the voxels along its path and accumulates visual properties (e.g., color, transparency) based on the transfer function and the effect of the light sources in the scene.

The “transfer function,” also known as a classification function or rendering setting, determines how various voxels in the image data appear in the rendered image. In particular, the transfer function may define the transparency, visibility, opacity or color for voxel (or intensity) values. The shading of the 3D representation in the rendered image provides information about the geometric properties (e.g., depth, width, height, etc.) of the region of interest. In addition, the color and/or transparency values in the 3D representation provide indications of the material properties (e.g., tissue densities) of the features in the region of interest.

One or more transfer functions may be applied in the present framework. In accordance with one implementation, the transfer function comprises a translucent transfer function. The translucent transfer function determines how visible various intensities are, and thus, how transparent corresponding materials are. The transfer function may cause the visualization unit 407 to render any voxels associated with a material that is likely to occlude the region of interest from a desired viewpoint as at least partially transparent. The likelihood of occlusion may be identified based on, for example, prior knowledge of the subject of interest. For example, in a virtual colonoscopy application, the colon wall is identified to likely occlude the region of interest within the colon, and is therefore rendered as at least partially transparent.

In one implementation, the translucent transfer function maps an intensity range associated with the identified material to a transparency value. This is possible because different materials are associated with different intensity ranges. For example, the intensity range associated with soft tissue (or fat) is around −120 to 40 Hounsfield units (HU). Different intensity ranges may also be associated with the materials if different imaging modalities are used to acquire the image data. Preferably, the intensity ranges associated with the identified materials do not overlap with each other. The intensity ranges may be stored locally in a computer-readable media 406 or retrieved from a remote database. Further, the intensity ranges may be selectable by a user via, for example, a graphical user interface.

In the context of virtual colonoscopy, the colon wall may be identified as being likely to occlude the region of interest. The intensity values associated with the colon wall are mapped to at least a partially transparent value so that the underlying region of interest may be visible. In addition, intensity values that are associated with materials (e.g., fatty tissue) identified as unimportant (or not of interest) may be mapped to higher or completely transparent values.

The transfer function may also comprise a color transfer function. In one implementation, the color transfer function causes the visualization unit 407 to render voxels representing one or more features within the region of interest in accordance with a color scheme. The features within the region of interest may include, for example, true polyps or muscle tissue or detected false-positives (e.g., fluid, residue, blood, stool, tagged material, etc.). The color scheme maps various intensity ranges (and hence different materials or features) to different color values. The colors may be selected to facilitate human perceptual discrimination of the different features in the rendered images. In one implementation, the colors comprise one or more shades of additive primary colors (e.g., red, green, blue, yellow, orange, brown, cyan, magenta, gray, white, etc.). Other perceptually distinctive colors may also be used.

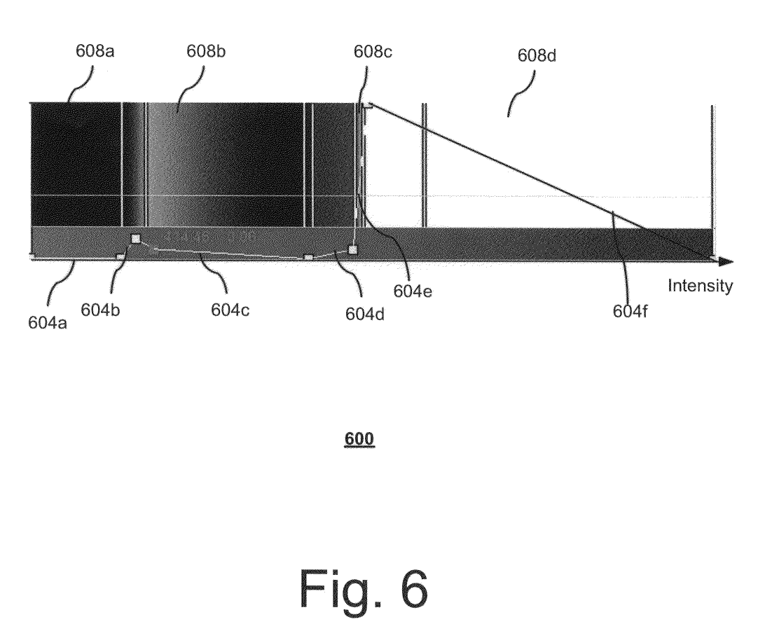

FIG. 6 shows an image 600 that illustrates an exemplary transfer function. The transfer function maps intensity values (shown on the horizontal axis) to various opacity (or transparency) values 604 a-f and color values 608 a-d. Different effects can be achieved by varying the colors and/or transparency values for different intensity ranges. For example, line segment 604a shows the mapping of an intensity range corresponding to fatty tissue to very low opacity values, thereby displaying fatty tissue as almost transparent in the rendered images. Line segment 604c illustrates the mapping of the intensity range associated with the colon wall to semi-opaque (or semi-transparent) values, and section 608b shows the mapping of the colon wall intensities to shades of reddish brown. Section 608c and line segment 604e shows the mapping of an intensity range associated with muscle tissue to red color values and to highly opaque values. Tagged materials are rendered as white and opaque, as shown by section 608d and line segment 604f. It is understood that such mappings are merely exemplary, and other types of mappings may also be applied, depending on, for example, the type of material or imaging modality.

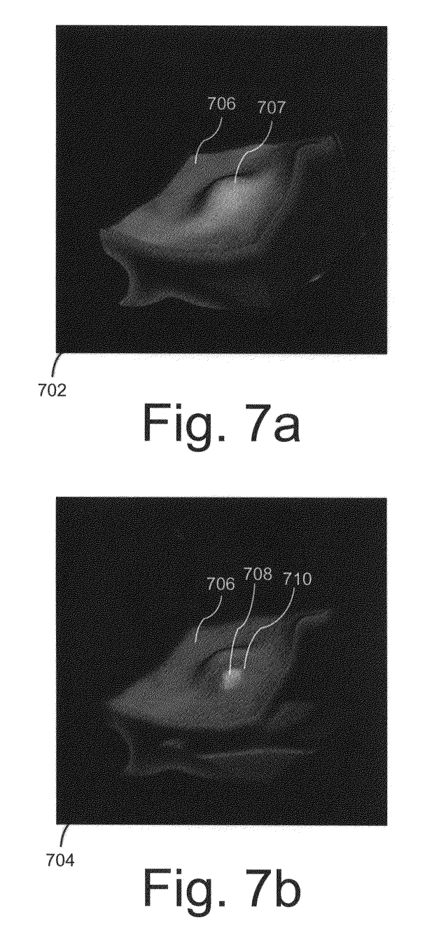

FIG. 7a depicts an image 702 rendered using standard volume rendering, and FIG. 7b depicts an image 704 rendered using volume rendering based on an exemplary transfer function in accordance with the present framework. As shown in image 702, the colon wall 706 is opaque and provides only geometric information about the suspicious-looking feature 707. Image 704, on the other hand, shows a semi-transparent colon wall 706, revealing underlying tissue 708 and tagged stool 710 with Hounsfield units encoded in red and white respectively. In addition to providing geometric information, the 3D surface rendering in image 704 allows the user to readily identify the underlying structures as false-positive tagged stool without having to switch to a 2D reading mode for closer inspection.

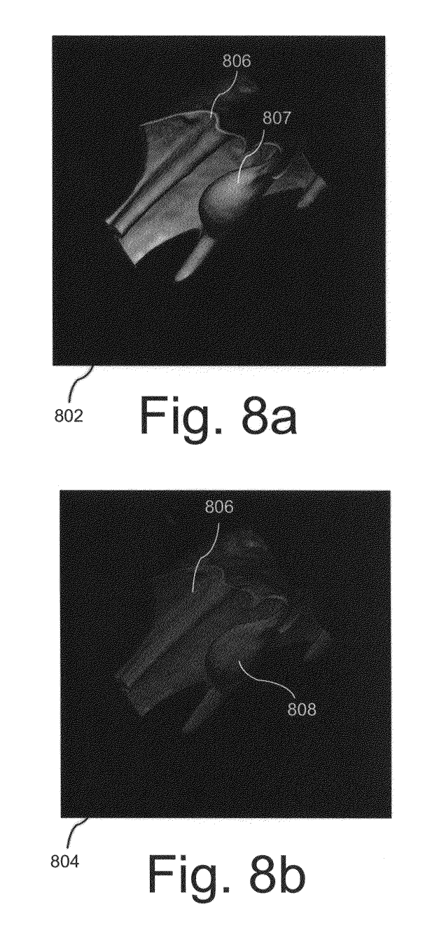

Similarly, FIG. 8a shows an image 802 generated by standard volume rendering, and FIG. 8b shows an image 804 generated by volume rendering based on an exemplary transfer function in accordance with the present framework. Image 802 shows an opaque colon wall 806 covering a suspicious-looking structure 807. Image 804 shows a colon wall 806 rendered as semi-transparent and fatty tissue rendered as transparent, revealing an underlying lipoma 808 in red.

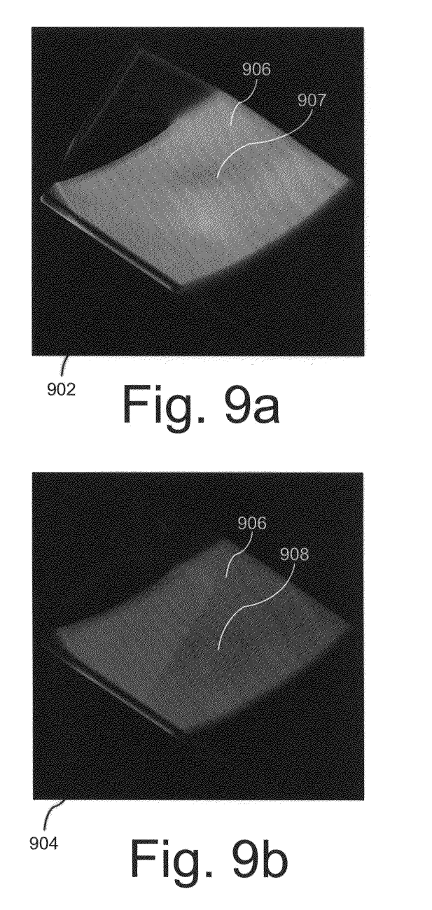

FIG. 9a shows an image 902 generated by standard volume rendering. As illustrated, an opaque colon wall 906 covers a very thin and flat true polyp 907. The user may miss the polyp 907 because it is hardly noticeable or conspicuous, and it looks similar to typical benign structures. FIG. 9b shows an image 904 generated by volume rendering based on the framework described herein. As shown, the underlying muscle tissue 908, which is rare in a benign structure, is clearly visible under the translucent colon wall 906. This helps the radiologist to quickly determine that a potentially malignant structure exists below the colon wall 906, prompting the radiologist to take additional steps towards patient care that otherwise may have been overlooked.

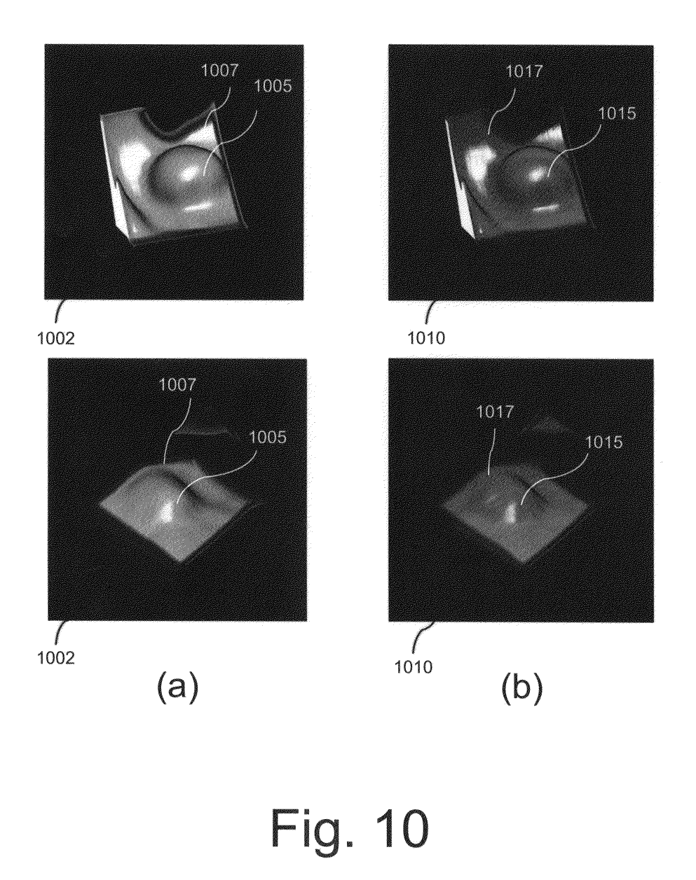

FIG. 10a shows images 1002 generated by standard volume rendering. As shown, an opaque wall 1007 covers a suspicious-looking polypoid shape 1005. FIG. 10b shows images 1010 rendered by the present framework. Muscle tissue 1015 is encoded in red color and conspicuously visible under semi-transparent colon wall 1017. By making underlying material directly visible in three-dimensional surface renderings, the present framework advantageously provides for a more intuitive evaluation of the structure in interest, resulting in improvements to the user's speed and accuracy of diagnosis and a reduction in the number of false-positives detected.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method of visualization, comprising:
receiving digitized image data, including image data of a region of interest; and
rendering a three-dimensional representation of the region of interest based on a transfer function, wherein the transfer function causes a computer system to render voxels representing a material that is likely to occlude the region of interest from a desired viewpoint as at least partially transparent and to render voxels representing one or more features within the region of interest in accordance with a color scheme.

2. The method of claim 1 further comprising acquiring, by an imaging device, the image data by computed tomography (CT).

3. The method of claim 1 further comprising pre-processing the image data by segmenting the one or more features in the region of interest.

4. The method of claim 1 wherein the image data comprises image data of a tube-like structure.

5. The method of claim 4 wherein the desired viewpoint is outside of the tube-like structure and the region of interest is within an interior portion of the tube-like structure.

6. The method of claim 4 wherein the material comprises material of a wall section of the tube-like structure, wherein the wall section is positioned between the region of interest and the desired viewpoint.

7. The method of claim 4 wherein the tube-like structure comprises a colon.

8. The method of claim 1 wherein the one or more features in the region of interest comprise muscle tissue.

9. The method of claim 1 further comprising receiving, via a user interface, a user selection of the region of interest.

10. The method of claim 1 wherein the rendering comprises volume ray casting, splatting, shear warping, texture mapping, hardware-accelerated volume rendering or a combination thereof.

11. The method of claim 1 wherein the color scheme maps intensity ranges to color values, wherein at least one of the intensity ranges is associated with a type of material.

12. The method of claim 1 wherein the color scheme comprises perceptually distinctive colors.

13. The method of claim 12 wherein the color scheme comprises additive primary colors.

14. A method of generating a virtual view of a colon for use in virtual colonoscopy, comprising:
receiving digitized image data of a portion of a colon including a region of interest within an interior portion of the colon; and
rendering, by the computer system, a three-dimensional representation of the portion of the colon based on a transfer function, wherein the transfer function causes a computer system to render voxels representing any wall portion of the colon as at least partially transparent and to render voxels representing one or more features in the region of interest in accordance with a color scheme.

15. The method of claim 14 further comprising acquiring, by an imaging device, the image data by computed tomography (CT).

16. The method of claim 14 wherein the transfer function further causes the computer system to render voxels representing fatty tissue as transparent.

17. The method of claim 14 wherein the one or more features in the region of interest comprise detected false positives.

18. The method of claim 14 wherein the one or more features in the region of interest comprise detected true positives.

19. A computer readable medium embodying a program of instructions executable by machine to perform steps for visualization, the steps comprising:
receiving digitized image data, including image data of a region of interest; and
rendering a three-dimensional representation of the region of interest based on a transfer function, wherein the transfer function causes the machine to render voxels representing a material that is likely to occlude the region of interest from a desired viewpoint as at least partially transparent and to render voxels representing one or more features within the region of interest in accordance with a color scheme.

20. A visualization system, comprising:
a memory device for storing computer readable program code; and
a processor in communication with the memory device, the processor being operative with the computer readable program code to:
receive digitized image data, including image data of a region of interest; and
render a three-dimensional representation of the region of interest based on a transfer function, wherein the transfer function causes the processor to render voxels representing a material that is likely to occlude the region of interest from a desired viewpoint as at least partially transparent and to render voxels representing one or more features within the region of interest in accordance with a color scheme.
